(19) United States
(12) Patent Application Publication
(10) Pub. No.: US 2017/0107910 A1
(43) Pub. Date: Apr. 20, 2017

(54) METHOD AND APPARATUS FOR STARTING AN AIRCRAFT ENGINE AND OPERATING A POWER ARCHITECTURE FOR AN AIRCRAFT

(71) Applicant: GE AVIATION SYSTEMS LLC, Grand Rapids, MI (US)

(72) Inventor: HAO HUANG, TROY, OH (US)

(21) Appl. No.: 15/081,156

(22) Filed: Mar. 25, 2016

Related U.S. Application Data
(60) Provisional application No. 62/241,996, filed on Oct. 15, 2015.

(51) Int. Cl. F02C 7/26; B60R 16/03; H02M 7/68

(52) U.S. Cl. CPC F02C 7/26; H02M 7/68; B60R 16/03; F05D 2260/85

(57) ABSTRACT

A method and apparatus for starting and operating at least a first starter/generator (S/G) and a second S/G using at least one bi-directional converter and at least one of an AC power source and a first DC power source, including selectively starting at least one of the first S/G or second S/G in an AC start mode or in a DC start mode, and supplying electrical power to a set of electrical loads.

### CROSS-REFERNCE TO RELATED APPLICATIONS

The present application claims the benefit of U.S. Provisional Patent Application No. 62/241996, filed Oct. 15, 2015, which is incorporated by reference herein in its entirety.

### BACKGROUND OF THE INVENTION

Contemporary aircraft engines include electric machines, or generator systems, which utilize a running aircraft engine in a generator mode to provide electrical energy to power systems and components on the aircraft. Some aircraft engines can further include starter/generator (S/G) systems, which act as a motor to start an aircraft engine, and as a generator to provide electrical energy to power systems on the aircraft after the engine is running. In these systems, for instance, variable voltage or variable frequency power is connected to drive the starter/generator in a starting mode. After starting, the starter/generator operates in a generating mode, converting the mechanical energy of the aircraft engine for generating power for the aircraft. The power generated by the starter/generator can be supplied to a power bus of the aircraft.

### BRIEF DESCRIPTION OF THE INVENTION

In one aspect, a method of starting an aircraft having at least a first turbine engine having a first starter/generator (S/G) and a second turbine engine having a second S/G using at least one bi-directional converter and at least one of an AC power source having an AC power output and a first DC power source having a DC power output, the method including selectively starting at least one of the first S/G or second S/G in an AC start mode, where the AC power output is supplied to a first bi-directional converter, which converts the AC power output to a second DC power output supplied to the at least one of the first S/G or second S/G, and in a DC start mode, where the DC power output is supplied to start the at least one of the first S/G or second S/G.

In another aspect, a power architecture for an aircraft, includes a power-generating source having a direct current (DC) power output, a primary power bus operating with DC power and coupled with the DC power output, a secondary power bus operating with alternating current (AC) power, and at least one bi-directional converter having a DC lead and an AC lead, and configured to bi-directionally convert DC power received at the DC lead to AC power at the AC lead, and to convert AC power received at the AC lead to DC power at the DC lead.

In yet another aspect, a method of operating a power architecture for an aircraft includes supplying DC power from a power-generating source to a primary DC power bus, converting, by a bi-directional converter, DC power from the DC power bus to AC power, and supplying the AC power to an AC power bus, and redundantly supplying the DC power and the AC power to respective DC and AC consuming electrical loads.

### BRIEF DESCRIPTION OF THE DRAWINGS

In the drawings:

FIG. 1 is a sectional view of a starter/generator assembly, in accordance with embodiments of the disclosure.

FIG. 2 is a schematic view of the electrical system, in accordance with embodiments of the disclosure.

FIG. 3 is an example a flow chart diagram of demonstrating a method starting the starter/generator assembly of FIG. 1, in accordance with various aspects described herein.

FIG. 4 is an example a flow chart diagram of demonstrating a method of operating the electrical system of FIG. 2, in accordance with various aspects described herein.

### DESCRIPTION OF EMBODIMENTS OF THE INVENTION

While the embodiments of the disclosure are generally directed to the starting of a jet engine, such as a turbine engine, such engines are typically started with an electric machine, and more specifically with an electric motor in the form of a starter/generator (S/G). Additionally, embodiments of the disclosure are generally directed to a power architecture for the aircraft, as well as a method for operating the same. Thus, a brief description of the operation of such an electric machine, which is used in the starting of a turbine engine and the generating of electricity for the power architecture of the aircraft, is provided for understanding.

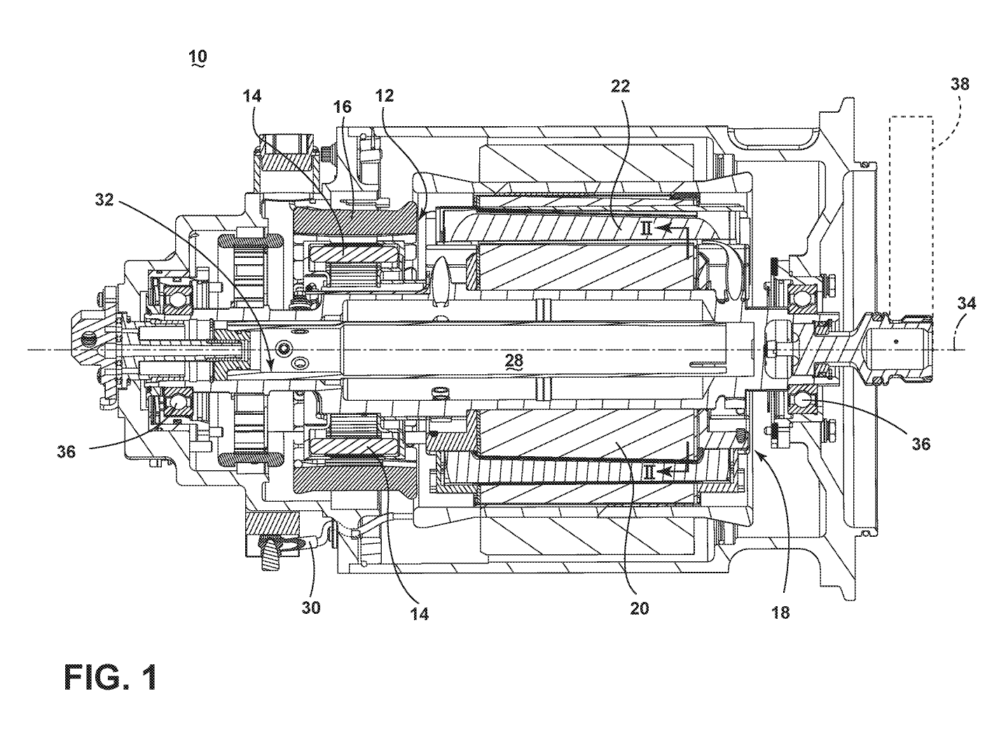

FIG. 1 illustrates an electric machine assembly 10 configured to be mounted on or within a gas turbine aircraft engine. The gas turbine engine can be a turbofan engine, such as a General Electric GEnx or CF6 series engine, commonly used in modern commercial and military aviation or it could be a variety of other known gas turbine engines such as a turboprop or turboshaft. The gas turbine engine can also have an afterburner that burns an additional amount of fuel downstream of the low pressure turbine region to increase the velocity of the exhausted gases, and thereby increasing thrust.

The electrical machine assembly 10 comprises a first machine 12 having an exciter rotor 14 and an exciter stator 16, and a synchronous second machine 18 having a main machine rotor 20 and a main machine stator 22. At least one power connection is provided on the exterior of the electrical machine assembly 10 to provide for the transfer of electrical power to and from the electrical machine assembly 10. Power is transmitted by this power connection, shown as an electrical power cable 30, directly or indirectly, to the electrical load and can provide for a three phase with a ground reference output from the electrical machine assembly 10.

The electrical machine assembly 10 further comprises a rotatable shaft 32 mechanically coupled to a source of axial rotation, which can be a gas turbine engine (not shown), about a common axis 34. The rotatable shaft 32 is supported by spaced bearings 36. The exciter rotor 14 and main machine rotor 20 are mounted to the rotatable shaft 32 for rotation relative to the stators 16, 22, which are rotationally fixed within the electrical machine assembly 10. The stators 16, 22 can be mounted to any suitable part of a housing portion of the electrical machine assembly 10. The electrical machine assembly 10 can also comprise a mechanical shaft 38 (shown as a schematic box) that couples the rotatable shaft 32, for instance, with the gas turbine engine (not shown). The mechanical shaft 38 is configured such that rotation of the rotatable shaft 32 produces a mechanical force that is transferred through the shaft 38 to provide rotation to the gas turbine engine.

In the illustrated embodiment, the second machine 18 is located in the rear of the electric machine assembly 10 and the first machine 12 is positioned in the front of the electric machine assembly 10. Other positions of the first machine 12 and the second machine 18 are envisioned.

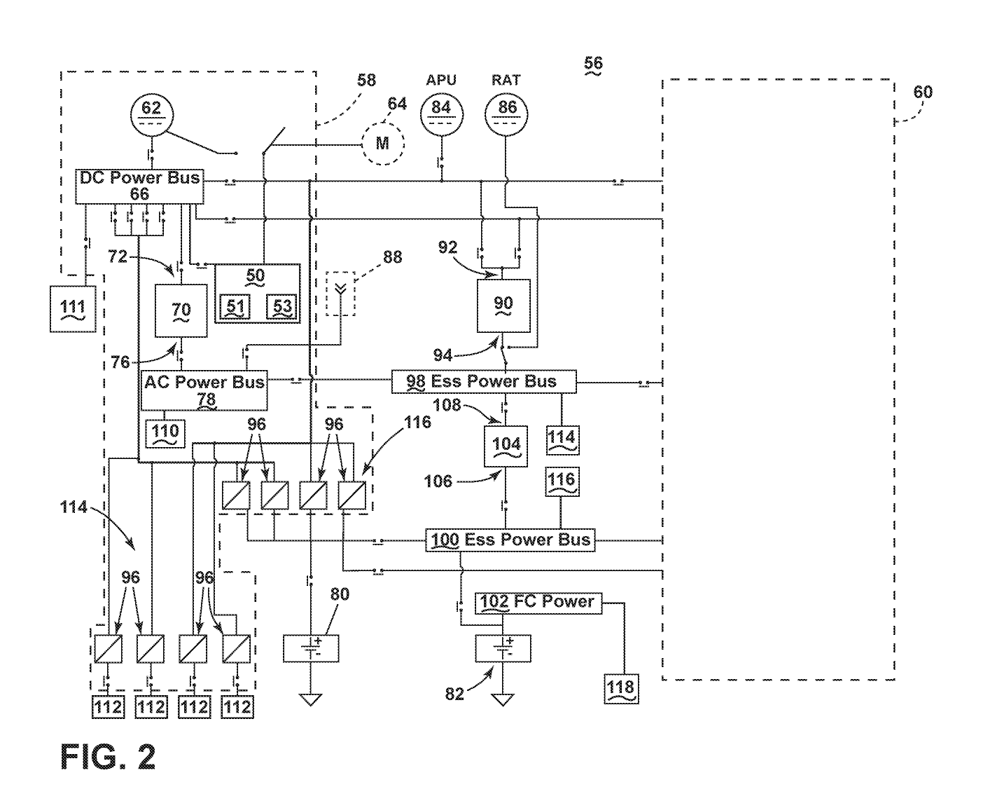

FIG. 2 illustrates a schematic block diagram of a power distribution system 56 according to an embodiment of the disclosure. The power distribution system 56 includes multiple engine systems, shown herein as including at least a first engine system 58 and a second engine system 60. Only the first engine system 58 is described for brevity and understanding. Embodiments of the second engine system 60 can include substantially similar configurations as the first engine system 58.

Non-limiting embodiments of the first engine system 58 can include a first starter/generator 62, such as the above described electric machine assembly 10. The first engine system 58 can further include a starter motor controller 50, a DC power bus 66, a first bi-directional converter 70 or inverter/converter having a DC lead 72 and an AC lead 76, a first AC power bus 78, and a set of converter integrated modular power tiles (CMPTs) 96. As illustrated, the starter motor controller 50 can be selectably coupled with at least one of the first starter/generator 62 or another device, such as a motor 64, illustrated outside of the first engine system 58. In a non-limiting example configuration, the motor 64 can include a motor 64 configured to operate the environmental control system of the aircraft.

The power distribution system 56 can include additional power sources, including, but limited to, at least one electrical storage device 80, at least one supplemental electrical storage device 82, an auxiliary power unit (APU) 84, a ram-air turbine system (RAT) 86, and an external AC power source 88. Non-limiting examples of the at least one electrical storage device 80 or the at least one supplemental electrical storage device 82 can include At least one battery, fuel cell, supercapacitor, or the like, and can further be configured or selected based on rechargeability.

The power distribution system 56 can further include a second bi-directional converter 90 having a corresponding DC lead 92 and a AC lead 94, an essential (ESS) AC power bus 98, an essential (ESS) DC power bus 100, a flight-critical (FC) power bus 102, and an essential (ESS) transformer rectifier unit (TRU) 104 having a DC lead 106 and an AC lead 108.

As shown, the DC power bus 66 is selectively coupled with the starter motor controller 50, the first starter/generator 62, the first DC lead 72 of the bi-directional converter 70, the APU 84, a set of CMPTs 96, and an example DC electrical load 111. The DC power bus 66 can further be selectively coupled with a second DC power bus of the second engine system 60. The DC power bus 66 can be a primary electrical bus in the aircraft power distribution system 56. The DC power bus 66 can also include electrical bus bars and be configured to distribute main DC power throughout the aircraft. In one non-limiting example embodiment of the disclosure, the DC power bus 66 can be configured to operate at 270 Volts DC (VDC). In this sense, the first starter/generator 62, the APU 84, or the DC lead 72 of the first bi-directional converter 70, or a DC power bus of the second engine system 60 can be selected, operated, or configured to generate and supply 270 VDC power to the DC power bus 66. Additionally, the DC electrical load 111 can be configured or selectively operated by the 270 VDC power supply. In one non-limiting example configuration, the first starter/generator 62 can be configured to operably convert or provide 270 VDC to the DC power bus 66 when operating in the generating mode. While 270 VDC is described, embodiments of the disclosure can include +270 VDC and −270 VDC.

A first subset 114 of the CMPTs 96 are shown coupled with a corresponding set of example DC electrical loads 112, while a second subset 116 of the CMPTs 96 are selectively coupled with the at least one electrical storage device 80 and the essential DC power bus 100. The CMPTs 96 can be operably configured to bi-directionally convert power from the DC power bus (e.g. at 270 VDC) to a second power, such as 28 VDC, and vice versa. In this sense, the DC electrical loads 112 can be selectively operated by the 28 VDC power supply from the corresponding CMPT 96. At least one of the first or second subsets 114, 116, or at least one CMPT 96 can be further selectively coupled with another DC power bus or another CMPT of the second engine system 60.

The AC power bus 78 is selectively coupled with the AC lead 76 of the first bi-directional converter 70, the essential AC power bus 98, the external AC power source 88, and an example AC electrical load 110. The AC power bus 78 can further be selectively coupled with a second AC power bus of the second engine system 60. The AC power bus 78 can be a secondary or auxiliary power bus in the power distribution system 56 of the aircraft. The AC power bus 78 can also include electrical bus bars and be configured to distribute main AC power throughout the aircraft, or to a set of selectable AC electrical loads 110.

In one non-limiting example embodiment of the disclosure, the AC power bus 78 can be configured to operate three phases of 115 Volts AC (VAC) power at 400 Hertz. In this sense, the RAT system 86, the external AC power source 88, or a second AC power bus of the second engine system 60 can be selected, operated, or configured to generate, supply, or provide 115 VAC power to the AC power bus 78. Additionally, the AC electrical load 110 can be configured or selectively operated by the 115 VAC power supply. While a three phase 115 VAC AC power bus 78 is described, non-limiting embodiments of the disclosure can be included wherein the AC power bus 78 operates at a single phase of 115 VAC power, and provides the single phase AC power to a set of single phase AC electrical loads. In another alternative embodiment, a single phase AC power bus can be included in addition to the AC power bus 78 described.

The essential AC power bus 98 can further be selectively coupled with the RAT system 86, the AC lead 94 of the second bi-directional converter 90, the AC lead 108 of the essential TRU 104, and an example essential AC electrical load 114. The essential AC power bus 98 can further be selectively coupled with the second AC power bus of the second engine system 60. In one non-limiting example embodiment of the disclosure, the essential AC power bus 98 can be configured to operate three phases of 115 VAC power at 400 Hertz. As previously explained, the RAT system 86, the AC power bus 78, or the second AC power bus of the second engine system 60 can be selected, operated, or configured to generate, supply, or provide any number of phases of 115 VAC power to the essential AC power bus 98. As used herein, an essential AC electrical load 114 can be a subset of one or more electrical loads of the power distribution system 56 classified or categorized as “essential” to the operation of the aircraft or essential aircraft systems.

The essential DC power bus 100 can further be selectively coupled with the electrical storage device 80, the supplementary electrical storage device 82, the DC lead 106 of the essential TRU 104 and an example essential DC electrical load 116. The essential DC power bus 100 can further be selectively coupled with the second DC power bus or a corresponding second set of CMPTs of the second engine system 60. In one non-limiting example embodiment of the disclosure, the essential DC power bus 100 can be configured to operate at 28 VDC power. In this sense, the essential DC power bus 100 can be supplied with 28 VDC power from at least one of the electrical storage device 80, the supplementary electrical storage device 82, the essential TRU 104, of the second DC power bus of the second engine system 60. As explained above, an essential DC electrical load 116 can be a subset of one or more electrical loads of the power distribution system 56 classified or categorized as “essential” to the operation of the aircraft or essential aircraft systems.

The FC power bus 102 can further be selectively coupled with the supplementary electrical storage device 82, the essential DC power bus 100, and an example flight-critical DC electrical load 118. In one non-limiting example embodiment of the disclosure, the FC power bus 102 can be configured to operate at 28 VDC power. In this sense, the FC power bus 102 can be supplied with 28 VDC power from at least one of the supplementary electrical storage device 82 or the essential DC power bus 100. A “flight-critical” DC electrical load 118 can be a subset of one or more electrical loads of the power distribution system 56 classified or categorized as “critical” to the operation of the aircraft or critical aircraft systems.

While examples of the electrical storage device 80 and the supplementary electrical storage device 82 have been described as operable to deliver 28 VDC power to the aforementioned power buses and electrical loads, embodiments of the disclosure can be included wherein at least one storage device 80, 82 can include a 270 VDC power source, and operable to deliver 270 VDC power to the aforementioned power buses and electrical loads. In another non-limiting example embodiment, a power converter can be included to covert 270 VDC power supplied by the at least one storage device 80, 82 to 28 VDC, as needed, based on the desired operation of the electrical loads. In yet another non-limiting example embodiments of the disclosure, at least one of the electrical storage devices 80, 82 can be configured to be rechargeable with DC power supplied by at least one of the DC power buses 66, 100.

Alternative configurations of the embodiments of the disclosure are envisioned having additional components shown and not shown. For instance, each engine system 58, 60 can further include additional electric machine assemblies 10, for instance, generators that are driven by the mechanical power of a running turbine engine. Additionally, each engine system 58, 60 can further include additional AC or DC power buses selectively coupled with each other or the respectively illustrated buses 66, 78. In another envisioned configuration, there can be at least one additional electrical storage devices 80, 82, APU 84, or external AC power source 88 for each respective engine 58, 60.

The bi-directional converters 70, 90 are both configured to invert DC power output received at the DC leads 72, 92 to AC power output supplied to the respective AC lead 76, 94. The bi-directional converters 70, 90 can further rectify the AC power output received at the AC leads 76, 94 to the respective DC leads72, 90. The bi-directional converters 70, 90 are configured to invert and rectify the respective power such that they produce the supplied power at the outputs at variable or predetermined electrical characteristics for each respective power bus, for instance 400 Hz, 115 VAC, 28 VDC, or 270 VDC, according to the design or desired operating characteristics of the power distribution system 56. Alternative rectified or inverter frequencies and voltages can be included. Embodiments of the disclosure are further included wherein the essential TRU 104 operates in a similar fashion of the bi-directional converters 70, 90, that is, it can be configured to both invert DC power received at the DC lead 106 to AC power supplied to the AC lead 108, or to rectify power in the reverse operation.

The CMPTs 96 or sets of CMPTs 114, 116 can act as a DC power pass-through, for instance, in transmitting the DC power output supplied from at least one of the electrical storage devices 80, 82, to the DC power bus 66, the APU 84, or the first starter/generator 62, to a DC electrical load 112, the essential DC power bus 100, the FC power bus 102, or vice versa. In addition to acting as a DC power pass-through, the CMPTs 96 or sets of CMPTs 114, 116 can convert the DC power output being transmitted in each direction to match the electrical characteristics of the destination. For instance, if the DC power bus 66 requires 270 VDC, and the electrical storage devices 80, 82 supplies 28 VDC, the CMPTs 96 or second set of CMPTs 116 can convert the 28 VDC supply to a 270 VDC output for the bus 78, or vice versa.

As shown, the external AC power source 88 supplies AC power directly to the AC power bus 78, thus, it is envisioned the source 88 supplies an AC power output matching the AC power characteristics of the AC bus 78, for instance, 115 VAC power at 400 Hz, in one or multiple power phases. The AC power bus 78 is additionally powered by the DC power bus 66, wherein the DC power output from the DC power bus 66 is rectified to a proper AC power bus signal by the respective bi-directional converters 70, 90.

The starter motor controller 50 can include at least one processor 51, and memory 53. The starter motor controller 50 can be further electrically coupled with additional power-supplying or power-generating components, for example, by way of the DC power bus 66. The starter motor controller 50 or processor 51 can be configured to operate in a first mode to start an unstarted first S/G 62, or in a second mode to operate the another device or motor 64. While operating in the first mode to start the unstarted first S/G 62, at least one of the starter motor controller 50 or the processor 51 can receive power provided to the DC power bus 66, and modify, convert, or apply the DC power to a power supply selected, operated, or desired to initiate the rotation of the rotatable shaft 32 of the first S/G 62. Ultimately, the at least one of the starter motor controller 50 or the processor 51 is configured to facility the self-sufficient operation of the first S/G 62 until the first S/G 62 operates to generate DC power, which it supplies to the DC power bus 66. Once the starter motor controller 50 or the processor 51 has started the respective S/G 62, the starter motor controller 50 or processor 51 can receive power provided to the DC power bus 66, and modify, convert, or apply the DC power to a power supply selected, operated, or desired to operate the motor 64, as needed.

The starter motor controller 50 or the processor 51 can be operably coupled with the memory 53, wherein the memory 53 can store a set of operational control profiles or programs for operating the starting of the first S/G 62 or operating the motor 64, as described herein.

The memory 53 can include random access memory (RAM), read-only memory (ROM), flash memory, or one or more different types of portable electronic memory, such as discs, DVDs, CD-ROMs, etc., or any suitable combination of these types of memory. The starter motor controller 50 or the processor 51 can be operably coupled with the memory 53 such that one of the starter motor controller 50 and the memory 53 can include all or a portion of a computer program having an executable instruct ion set for controlling the operation of the aforementioned components, or a method of operating the same. The program can include a computer program product that can include machine-readable media for carrying or having machine-executable instructions or data structures stored thereon. Such machine-readable media can be any available media, which can be accessed by a general purpose or special purpose computer or other machine with a processor. Generally, such a computer program can include routines, programs, objects, components, data structures, algorithms, etc., that have the technical effect of performing particular tasks or implement particular abstract data types.

Machine-executable instructions, associated data structures, and programs represent examples of program code for executing the exchange of information as disclosed herein. Machine-executable instructions can include, for example, instructions and data, which cause a general purpose computer, special purpose computer, starter motor controller 50, processor 51, or special purpose processing machine to perform a certain function or group of functions. In implementation, the functions can be converted to a computer program comprising a set of executable instructions, which can be executed by the processor 51.

The first S/G 62 and starter motor controller 50 can operate in two distinct modes: a starting mode and a generating mode. During the starting mode, the starter motor controller 50 operates to receive DC power from the DC power bus 66, and selectively provides a power output configured to provide starting torque and acceleration of the rotatable shaft 32 of the first S/G 62. During the generating mode, the first S/G 62 operates by steady-state self-sufficiency, and generates a DC power output, and the starter motor controller 50 selectively provides a power output configured to provide the motor 64 power to operate, as desired. In the above-described modes of operation, the power output of the starter/motor controller 50 can be converted, altered, or modified to match a set of desired power characteristics for the respective starting or generating modes.

At a beginning of the starting mode, the rotatable shaft 32 of the first S/G 62 is not rotating. From this condition, the starter motor controller 50 receives a DC power output from the DC power bus 66 and converts the DC power output to a starting power, such as a starting AC power or a starting DC power, which is further supplied to the first S/G 62. The starting AC or DC power is driven into, for instance, the main machine stator 22 or stator windings to generate a rotating magnetic field in the main machine stator 22, which in turn induces a current on the main machine rotor 20. The ensuing induced current generates sufficient torque upon the main machine rotor 20 to begin rotation of the attached rotatable shaft 32.

Embodiments of the electric machine assembly 10 are envisioned wherein the starter motor controller 50 or the processor 51 operably controls the first S/G 62 during the starting mode, such that the DC power supplied by the DC power bus 66 used to start the rotation of the main machine rotor 20 is supplied according to a starting sequence, method, predetermined profile, optimized operation, frequency stepping-operation, or by a dynamic feedback profile based on physical or electrical characteristics of the electric machine assembly such as rated voltage or temperature measurements. Any of the aforementioned starting methods can be stored in the starter motor controller 50, the processor 51, or the memory 53. While the above-described embodiment of the disclosure explains that the starting mode DC power is supplied by the DC power bus 66, alternative example configurations of the disclosure can be included wherein the starting mode DC power is supplied by any of the aforementioned power sources, including, but not limited to, the APU 84, the RAT 86, an electrical storage device 80, 82, an operating starter/generator, a power bus 66, 98, 78, 100, 102, or any of the aforementioned components of the second engine system 60.

Once the rotatable shaft 32 reaches a minimal operational frequency, for instance, as defined by the method or starting sequence, the first S/G 62 changes from starting mode to generating mode. At the time of this mode change, the main machine rotor 20 can be rotating, but not at an expected operational speed for the electric machine assembly 10. Additionally at the time of this mode change, the starter motor controller 50 or the processor 51 can modify the operation of the starter motor controller 50 to reverse the flow of power. In this sense, during the generating mode, the first S/G 62 can initiate providing power generated to the DC power bus 66, and the starter motor controller 50 can initiate providing power to the motor 64.

Additionally, the rotation of the rotating shaft 32 can supply the mechanical energy, via the mechanical shaft 38, necessary to start the gas turbine engine. The aforementioned method of starting an electrical machine assembly 10 is merely a non-limiting example of starting a synchronous electric machine using DC power.

Embodiments of the disclosure provide a robust power distribution system 56 for powering electrical loads on an aircraft. Embodiments of the disclosure further provide a robust electrical starting system for starting an aircraft, including, but not limited to, starting at least one of the first starter/generator 62, a starter/generator of the second engine system 60, or the APU 84 in an AC start mode from the AC power output of the external AC power source 88 or in a DC start mode from the DC power output from the electrical storage device 80.

For example, the power distribution system 56 can begin the starting method in the power distribution system 56 with a non-generating (unstarted) APU 84, and non-running first and second turbine engines 58, 60. The starting method can initially use the external AC power source 88 to supply the starting power in an AC start mode by selectively providing the AC power output to the AC power bus 78, for instance, which then supplies the AC power output to the AC lead 76 of the first bi-directional converter 70. The first bi-directional converter 70 can rectify the AC power to a starting DC power, and provide or supply the starting DC power to the DC power bus 66. Alternatively, the starting method can initially use at least one electrical storage device 80, 82 to supply the starting power by selectively providing the DC power output directly to at least one CPMT 96, for instance, which can convert the DC power to the DC power of the DC power bus 66, and supply the converted power to the DC power bus 66. The now-energized DC power bus 66 can supply the starting DC power to at least one of the APU 84 or a starter/generator 62 (e.g. in the first or second engine system 58, 60) of the aircraft to be started.

In the event that the DC power output is supplied to the APU 84, the power can be selectively used to provide starting power for the APU 84, as described in the starting method above. In the event that the DC power output is supplied to the a starter/generator 62 of the first or second engine systems 58, 60, the power can selectively provide starting power for the starter/generator 62, and thus the respective engine system 58, 60. Once at least one of the APU 84, a starter/generator 62, or the first or second engine system 58. 60 has been started into generating mode (hereinafter, “the generating source”), the remaining, non-started and non-generating components (hereinafter, “the non-generating components”) of the power distribution system 56, can be started. This starting method can also be accomplished in a number of ways. For example, the same external AC power source 88, electrical storage device 80, 82 used to start the generating source can be used for starting the remaining non-generating components, via any of the aforementioned selectively coupled electrical paths.

In another example, the generating source can be able to provide the starting power for the non-generating components. For instance, if the first starter/generator 62 is operating in generating mode, having been initially started as explained above, the first starter/generator 62 can act as a DC power source, and provide a DC power output to the DC power bus 66. From here, the DC power bus 66 can selectively supply the DC power output to start any or all of the non-generating components into a generating mode. As before, while the above example demonstrate using components of the first engine system 58 to start at least one of the first starter/generator 62, the APU 84, or the second engine system 60 in a DC start mode, similar processes are envisioned for starting the first starter/generator 62, or the APU 84 using the opposing components of the second engine system 60.

Any number of permutations can be envisioned wherein at least one of the electrical storage devices 80, 82 or the external AC power source 88 initially start at least one of the first starter/generator 62, APU 84, or second engine system 60 into a generating mode. Once a first generating source has been initially started, any of the electrical storage devices 80, 82, external AC power source 88, or first generating source can provide starting power to start a second non-generating component into a generating mode. Once the second generating source has been started, any of the electrical storage device 80, external AC power source 88, first generating source, or second generating source can provide starting power to further start further non-generating component into a generating mode.

It is important to note that different power sources can be used at different steps in the method. For instance, the electrical storage devices 80, 82 can start the APU 84, the APU 84 can start the first starter/generator 62, and the external AC power source 88 can start the second engine system 60. In another example, the external AC power source 88 can start each of the APU 84, first starter/generator 62, and the second engine system 60, in any order. It is also envisioned that any combination of power sources can provide starting power, such as combining the external AC power source 88 with the electrical storage devices 80, 82, or combining the APU 84 with the external AC power source 88.

Thus, embodiments of the disclosure generally relate to an aircraft electrical power system. More specifically, the embodiments described herein provide for alternating current (AC) electrical power supplied, powered or otherwise generated from high voltage direct current (DC) main power onboard an aircraft. For example, the embodiments described herein can provide for a +/− 270Vdc system for the main and auxiliary power unit (APU) power, and a 115 VAC system for the ram air generator and essential and nonessential 115 VAC buses. Additionally or alternatively, converter integrated module power tiles (CMPTs) can be configured in the electrical power system to provide 28 VDC power to 28 Vdc essential buses, and provide equivalent redundancy capability of conventional Transformer Rectifier Units (TRUs). The conversion portion of the CMPT can enable +/− 270 Vdc power transmission instead of 28 Vdc, and thus significantly reduce cable weight.

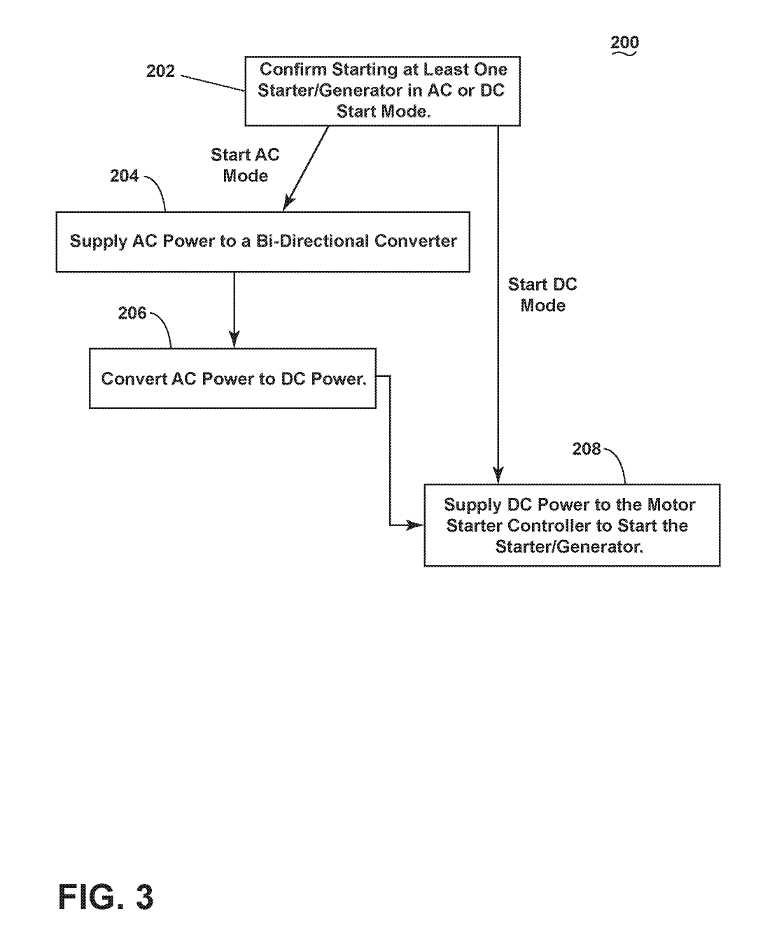

FIG. 3 illustrates a non-limiting flow chart demonstrating an example method 200 of starting an aircraft. The method 200 begins by confirming the starting of at least one starter/generator in AC or DC start mode at 202. If AC start mode is confirmed, the method 200 operates to selectively starting the starter/generator in AC start mode. The method 200 then proceeds to supply AC power from an AC power source to a bi-directional converter at 204, as explained above. The bi-directional converter then converts the AC power to a DC power at 206. The method 200 then supplies the DC power to a motor starter controller, as explained herein, to start the starter/generator at 208. If DC start mode is confirmed, the method 200 proceeds directly to supplying the DC power to the motor starter controller at 208.

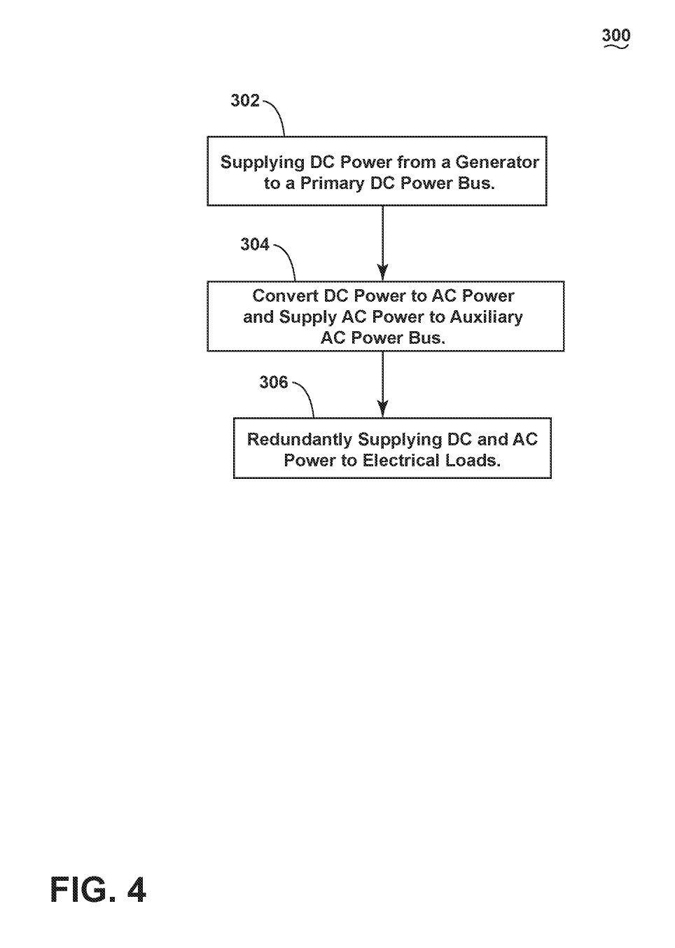

FIG. 4 illustrates a non-limiting flow chart demonstrating an example method 300 of operating a power architecture for the aircraft. The method 300 begins by supplying DC power from a power-generating source to a primary DC power bus at 302. The method 302 continues by converting, by a bi-directional converter, the DC power from the DC power bus to AC power, and further supplying the AC power to an AC power bus, such as a secondary power bus, at 304. The method 306 can also include redundantly supplying the DC power and the AC power to respective DC and AC consuming electrical loads at 306.

The sequence depicted in the above-described flow charts are for illustrative purposes only and is not meant to limit the methods 200, 300 in any way as it is understood that the portions of the methods can proceed in a different logical order, additional or intervening portions can be included, or described portions of the methods can be divided into multiple portions, or described portions of the methods can be omitted without detracting from the described methods.

Many other possible embodiments and configurations in addition to that shown in the above figures are contemplated by the present disclosure. For example, one embodiment of the disclosure contemplates additional generating components (e.g. additional starter/generators, generators, or a second APU) that can be started by extrapolating the above method to additional permutations. In another embodiment of the disclosure, the starter/generators 62 can be configured to start respective gas turbine engines. In this example, the gas turbine engine can further provide mechanical force, for example, via a high pressure, low pressure, or intermediary spool, to operate another generator in generating mode. This aforementioned generator or generators can further be selectively coupled with any of the AC or DC power buses 66, 78, and can provide additional starting power for starting another starter/generator, APU, or turbine engine.

The embodiments disclosed herein provide a method of operating a power distribution system and starting an aircraft having power generating components. The technical effect is that the above described embodiments enable the operating of the power distribution system as well as the selective starting operation of the power-generating systems by way of AC or DC power. One advantage that can be realized in the above embodiments is that the above described embodiments provide a robust starting method that allows starting from an AC or DC power sources. With the proposed electrical starting system, an aircraft can be started using a multitude of convenient power sources without the need for intermediary power conversion componentry on the ground or within the aircraft. By reducing the number of components, the above described embodiments have superior weight and size advantages over the conventional type APU, pneumatic, and electrical starting systems.

Another advantage of the above embodiments is that by providing a primary power distribution bus configured to operate DC power, such as 270 VDC, the power distribution system enables reduction in power transmission cable weight, while still providing the expected redundancy in power system operation. In this sense, operating the primary power distribution bus as high voltage DC power bus increases the operating and electrical efficiency of the power distribution system. Furthermore, by utilizing the CMPTs to enable 270 VDC to 28 VDC conversion, the CMPTs can be located proximate to the 28 VDC electrical loads, further reducing the cable weight needed to operate the 28 VDC loads. Additionally, by incorporating the bi-directional converters, existing AC-based electrical loads including on-board equipment, instruments, and the like, can be incorporated into the aircraft, and still powered by way of, for example supplementary power buses (e.g. the AC power bus). Additionally, the bi-directional converter enables the use of pre-existing RAT systems that generate AC power.

Yet another advantage of the above mentioned embodiments is that the selective coupling between the components, such as the AC power buses, DC power buses, and bi-directional converters, provides for a highly redundant electrical starting system during normal and emergency operations. For example, the second engine system 60 needs to be started in emergency operation during flight, yet the selective coupling between the DC power buses 66 and the DC power bus of the second engine system 60 has failed, the electric starting system provides that power from a generating or power source can be selectively transmitted through, for example, converting the generated power from the DC power bus 66 to the first bi-directional converter 70, transmitting the converted power from the first bi-directional converter 70 to the AC power bus 78, selectively coupling the AC power bus 78 with an AC power bus of the second engine system 60, rectifying the power by way of a bi-directional converter of the second engine system 60, and supplying the rectified power to the DC power bus of the second engine system 60 to provide starting capability for the second engine system 60.

When designing aircraft components, important factors to address are size, weight, and reliability. The above described electrical starting system has a decreased number of parts, yet provides redundant starting operation, making the complete system inherently more reliable. This results in a lower weight, smaller sized, and increased reliability system. The lower number of parts and reduced maintenance will lead to lower product costs and lower operating costs. Reduced weight and size correlate to competitive advantages during flight.

To the extent not already described, the different features and structures of the various embodiments can be used in combination with each other as desired. That one feature cannot be illustrated in all of the embodiments is not meant to be construed that it cannot be, but is done for brevity of description. Thus, the various features of the different embodiments can be mixed and matched as desired to form new embodiments, whether or not the new embodiments are expressly described. Moreover, while “a set of” various elements have been described, it will be understood that “a set” can include any number of the respective elements, including only one element. Combinations or permutations of features described herein are covered by this disclosure.

This written description uses examples to disclose embodiments of the invention, including the best mode, and also to enable any person skilled in the art to practice embodiments of the invention, including making and using any devices or systems and performing any incorporated methods. The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of starting an aircraft having at least a first turbine engine having a first starter/generator (S/G) and a second turbine engine having a second S/G using at least one bi-directional converter and at least one of an AC power source having an AC power output and a first DC power source having a DC power output, the method comprising:
selectively starting at least one of the first S/G or second S/G in an AC start mode, where the AC power output is supplied to a first bi-directional converter, which converts the AC power output to a second DC power output supplied to the at least one of the first S/G or second S/G, and in a DC start mode, where the DC power output is supplied to start the at least one of the first S/G or second S/G.

2. The method of claim 1 further comprising selectively starting the other of the at least one first S/G or second S/G in the AC start mode, where the AC power output is supplied to a first bi-directional converter, which converts the AC power output to a second DC power output supplied to the at least one of the first S/G or second S/G, and in the DC start mode, where the DC power output is supplied to the at least one of the first S/G or second S/G.

3. The method of claim 1, further comprising selectively starting the other of the at least one first S/G or second S/G by a second DC power output from the started at least one first S/G or second S/G.

4. The method of claim 3 wherein the second DC power output is selectively supplied to a first bi-directional converter, operating the bi-directional converter to convert the second DC power output to a second AC power output, supplying the second AC power output to a second bi-directional converter and outputting a third DC output, which is then supplied to the other of the at least one first S/G or second S/G.

5. The method of claim 1, further comprising selectively starting an auxiliary power unit (APU) to generate the DC power output.

6. The method of claim 5, further comprising selectively starting the other at least one first S/G or second S/G by the DC power output from the started APU.

7. The method of claim 6 wherein the AC power output is selectively supplied to a first bi-directional converter, operating the bi-directional converter to convert the DC power output to a second AC power output, supplying the second AC power output to a second bi-directional converter and outputting a second DC output, which is then supplied to at least one of the first S/G or second S/G.

8. The method of claim 5 wherein the selectively starting the APU occurs prior to selectively starting the at least one first S/G or second S/G.

9. The method of claim 1 further comprising supplying the DC power output to a starter motor controller configured to start the at least one first S/G or second S/G.

10. The method of claim 9 wherein the DC power output is selectively supplied to a first bi-directional converter, operating the bi-directional converter to convert the DC power output to a second AC power output, supplying the second AC power output to a second bi-directional converter and outputting a second DC output, which is then supplied to at least one of the first S/G or second S/G.

11. A power architecture for an aircraft, comprising:
a power-generating source having a direct current (DC) power output;
a primary power bus operating with DC power and coupled with the DC power output;
a secondary power bus operating with alternating current (AC) power; and
at least one bi-directional converter having a DC lead and an AC lead, and configured to bi-directionally convert DC power received at the DC lead to AC power at the AC lead, and to convert AC power received at the AC lead to DC power at the DC lead.

12. The power architecture of claim 11, wherein the power generating source is at least one of a starter/generator, a battery, a super capacitor, or an auxiliary power unit.

13. The power architecture of claim 11 further including at least one DC-consuming electrical load and at least one AC-consuming electrical load.

14. The power architecture of claim 13 further including a converter integrated module power tiles configured to covert the DC power output to a second DC power output.

15. The power architecture of claim 14 further including at least a second DC-consuming electrical load configured to consume the second DC power output.

16. A method of operating a power architecture for an aircraft, comprising:
supplying DC power from a power-generating source to a primary DC power bus;
converting, by a bi-directional converter, DC power from the DC power bus to AC power, and supplying the AC power to an AC power bus; and
redundantly supplying the DC power and the AC power to respective DC and AC consuming electrical loads.

17. The method of claim 16, further comprising starting a non-operating power-generating source from at least one of an AC power source in an AC start mode or a DC power source in a DC start mode, wherein AC power is supplied to a the bi-directional converter, which converts the AC power to DC power and supplies the DC power to the non-operating power-generating source, and in a DC start mode, where the DC power is supplied to the non-operating power-generating source to start the non-operating power-generating source into the power-generating source.

18. The method of claim 17 wherein the starting a non-operating power-generating source includes starting at least one of a starter/generator, an auxiliary power unit, or an aircraft engine system.

19. The method of claim 17, further comprising starting another non-operating power-generating source from the started power-generating source.

20. The method of claim 16 wherein the supplying DC power includes supplying DC power from at least one of a starter/generator, a battery, a super capacitor, or an auxiliary power unit.
